(19) United States
(12) Patent Application Publication
(10) Pub. No.: US 2004/0157980 A1
(43) Pub. Date: Aug. 12, 2004

(54) Coating composition with improved hardness, mar and etch resistance

(76) Inventors: Michael D. Fox, Rochester, MI (US); Walter C. Meyer, Rochester Hills, MI (US); George T. Schumacher, Kalamazoo, MI (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/359,420

(22) Filed: Feb. 6, 2003

(51) Int. Cl. C08K 3/00

(52) U.S. Cl. 524/547

(57) ABSTRACT

The present invention relates to a coating composition particularly useful as a clear coating used over a pigmented base coat that has improved cure, which provides increased out of oven hardness, as well as improved mar and scratch resistance, and increased environmental chemical resistance. The composition is comprised of 40-70% by weight of film forming binder and 30-60% by weight of a volatile liquid carrier for the binder; wherein the binder contains a 25-98.5% by weight, based on the weight of the binder, of a silane polymer, 1-40% by weight, based on the weight of the binder, of an alkylated melamine crosslinking agent, 0.5-5% by weight, based upon the weight of the binder, of an aryl or alkyl acid phosphate curing agent, and 0-30% by weight, based upon the weight of the binder, of a non aqueous dispersed polymer, a urethane polymer, a polyester resin, an acrylic polyol resin, or any mixture thereof. The composition may be used, in particular, as a finish for automobiles and light trucks.

### BACKGROUND OF THE INVENTION

1. Field of the Invention

This invention is directed to coating compositions, in particular to a clear coating composition used as a clearcoat over a color coating or base coating of a motor vehicle that has improved out of oven hardness, scratch and mar resistance, as well as environmental etch resistance.

2. Description of Related Art

The finish of choice presently being used on the exterior of automobiles and trucks is a basecoat/clearcoat finish in which a clear coating is applied over a pigmented color coating or base coating to provide protection to the color coat and improve the appearance of the overall finish, particularly gloss and distinctness of image. Acid rain and other air pollutants have caused problems of water spotting and acid etching of these finishes. In the time period immediately after the finish has been applied and cured, the sensitivity to spotting and etching is highest.

Another problem associated with some clear coats is lack of hardness immediately after baking in an oven. This softness leads to marring or scratching of a recently cured film. Scratching or marring of the finish can be caused by mechanical washing procedures used in a typical commercial car wash or by other mechanical force applied to the finish. Further, during the repair processing of a painted vehicle in a typical automotive OEM (original equipment manufacturing) assembly plant, repair efficiency and quality are often compromised by a soft clear coat finish.

Thus, there is need for OEM clearcoat compositions which form finishes resistant to environmental etching due to acid rain spotting, as well as increased mar and scratch resistance through increased in plant out of oven hardness.

### BRIEF SUMMARY OF THE INVENTION

A coating composition comprising 40-70% by weight of film forming binder and 30-60% by weight of a volatile liquid carrier for the binder; wherein the binder contains:

a. about 25-98.5% by weight of an acrylosilane polymer containing about 30-95% by weight based, based on the weight of the acrylosilane polymer, of polymerized monomers of styrene, alkyl (meth)acrylates having 1-12 carbon atoms in the alkyl group and hydroxy alkyl (meth)acrylates having 1-4 carbon atoms in the alkyl group and any mixtures thereof and 5-70% by weight, based on the weight of the polymer, of polymerized ethylenically unsaturated monomers containing reactive silane groups and the polymer has a weight average molecular weight of about 1,000-30,000;

b. about 0.5 to 5% by weight, based on the weight of the binder, of a curing agent, employed to catalyze the crosslinking of the silane moieties in said acrylosilane polymer, said curing agent is an aryl or alkyl acid phosphate, either amine blocked or unblocked,

c. about 1 to 40% by weight, based upon the weight of the binder, of an alkylated melamine crosslinking agent, and

d. about 0 to 30% by weight, based upon the weight of the binder, of non-aqueous dispersed polymer, urethane polymer, polyester resin, acrylic polyol resin, or any mixture thereof.

### DETAILED DESCRIPTION OF THE INVENTION

The coating composition of this invention is generally used as a clear coating composition that is applied over a base coat, which is a pigmented coating composition. Basecoat/clearcoat finishes are conventionally used on the exterior of automobiles and trucks. The coating composition of this invention forms a clear finish, has improved scratch and mar resistance, environmental chemical etch resistance, and increased in plant out of oven hardness.

For a typical auto or truck body, sheet steel, aluminum, plastic, or a composite can be used. If steel is used, it is typically first treated with an inorganic conversion coating such as zinc or iron phosphate. Then a primer coating may be applied by electrodeposition. Typically, electrodeposition primers are epoxy modified resins crosslinked with blocked polyisocyanate and are applied by a cathodic electrodeposition process. Optionally, a primer can be applied over the electrodeposited primer, usually by spraying, to provide better appearance and/or improved adhesion of the basecoat to the primer. A pigmented basecoat or colorcoat is then applied. A typical basecoat comprises pigment which can include metallic flake pigments such as aluminum flake or pearl flake pigments, a film forming binder which can be a polyurethane, an acrylourethane, an acrylic polymer or a silane polymer, and may contain a crosslinking agent such as an aminoplast, typically, an alkylated melamine formaldehyde crosslinking agent or a polyisocyanate. The basecoat can be solvent or water borne and can be in the form of a dispersion or a solution.

A clear coat or topcoat then is applied to the colorcoat or basecoat before the basecoat is fully cured and the basecoat and clearcoat are then fully cured usually by baking at 80-150 degree C. for 10-45 minutes. The basecoat typically has a dry coating thickness of 2.5-75 microns and the clearcoat typically has dry coating thickness of 25-100 microns.

The present invention is a clearcoat composition comprising an aryl or alkyl acid phosphate curing agent, a silane containing polymer, an optional alkylated melamine crosslinking agent, and an optional non-aqueous dispersion, acrylic, polyester, or urethane resin. The acid phosphate curing agent catalyzes the crosslinking reaction of alkoxy silane functional groups, during a curing cycle. This provides increased hardness and etch resistance as compared to conventional organo-tin or sulfonic acid catalysts. Further, this invention may enable lower temperature curing, allowing for a wider variety of substrate applications, especially for a non-isocyanate crosslinked system. At elevated curing temperatures, this invention may provide equivalent hardness and etch resistance at reduced alkoxysilane levels.

The clear coat composition of this invention contains 40 to 70% by weight of a film forming binder and 30 to 60% of a volatile organic liquid carrier. The clear coat also can be in dispersion form. The film forming binder of the clear coat composition contains 25 to 98.5%, preferably 45 to 95%, and more preferably 60 to 90%, by weight of an acrylosilane polymer having reactive silane and optionally hydroxyl groups, 1 to 40%, preferably 9 to 37%, by weight of an alkylated melamine crosslinking agent, 0.5 to 5%, preferably 1 to 4%, by weight of an aryl or alkyl acid phosphate curing agent, which is either amine blocked or unblocked, and 0 to 30%, preferably 15 to 25%, by weight of an optional polymer which may be a non-aqueous dispersed polymer, urethane polymer, polyester resin, acrylic polyol resin, and any mixture thereof.

The acrylosilane polymer comprises polymerized non-silane containing monomers of alkyl (meth)acrylates, with 1-12 carbon atoms in the alkyl groups, cycloaliphatic (meth)acrylates with 3-12 atoms in the alkyl groups, styrene, or mixtures of the above monomers. The polymer may contain polymerized hydroxy containing monomers such as hydroxyalkyl methacrylate, hydroxyalkyl acrylate each having 1-4 carbon atoms in the alkyl group or a mixture of these monomers and contains polymerized mono ethylenically unsaturated silane monomers. The acrylosilane polymer has a weight average molecular weight of 1,000-30,000. All molecular weights disclosed herein are determined by gel permeation chromatography (GPC).

Preferred acrylosilane polymers contain 35-75% by weight of polymerized alkyl methacrylate or alkyl acrylate or styrene monomers or mixtures thereof, 20-40% by weight of polymerized hydroxy alkyl methacrylate or acrylate monomers or mixtures thereof and 5-25% by weight of the mono ethylenically unsaturated silane monomer.

One preferred acrylosilane polymer is the polymerization product of 35-75% by weight of non silane containing monomers of an alkyl methacrylate, an alkyl acrylate each having 1-8 carbon atoms in the alkyl group, styrene or mixtures of these monomers; 20-40% by weight of hydroxy alkyl methacrylate having 1-4 carbon atoms in the alkyl group; and 5-25% by weight of a mono-ethylenically unsaturated silane containing monomer.

Typically useful ethylenically unsaturated non-silane containing monomers are alkyl acrylates, alkyl methacrylates where the alkyl groups have 1-12 carbon atoms such as methyl methacrylate, ethyl methacrylate, propyl methacrylate, butyl methacrylate, isobutyl methacrylate, pentyl methacrylate, hexyl methacrylate, octyl methacrylate, nonyl methacrylate, lauryl methacrylate; methyl acrylate, ethyl acrylate, propyl acrylate, butyl acrylate, isobutyl acrylate, pentyl acrylate, hexyl acrylate, octyl acrylate, nonyl acrylate, and lauryl acrylate. Cycloaliphatic alkyl methacrylates and acrylates also can be used, for example, such as cyclohexyl methacrylate, cyclohexyl acrylate, trimethylcyclohexyl methacrylate, trimethylcyclohexyl acrylate, iso-butyl methacrylate, t-butylcyclohexyl acrylate, t-butyl cyclohexyl methacrylate, isobomyl methacrylate, isobomyl acrylate and the like. Aryl acrylates and aryl methacrylates also can be used, for example, such as benzyl acrylate and benzyl methacrylate. Mixtures of two or more of the above mentioned monomers are useful in formulating the polymer with the desired characteristics.

In addition to alkyl acrylates or methacrylates, other non-silane containing polymerizable monomers in amounts up to 50% by weight of the polymer can be used in a silane polymer for the purpose of achieving the desired physical properties such as hardness, appearance, and mar resistance. Exemplary of such other monomers are styrene, methyl styrene, acrylamide, acrylonitrile, and methacrylonitrile. Styrene can be used in the range of 0-30% by weight.

Hydroxy functional monomers may be incorporated into the silane polymer to produce a polymer having a hydroxy number of 20 to 150. Typically useful hydroxy functional monomers are hydroxy alkyl methacrylates and acrylates such as hydroxyethyl methacrylate, 2-hydroxypropyl methacrylate, 3-hydroxypropyl methacrylate, hydroxybutyl methacrylates, hydroxyisobutyl methacrylate, hydroxyethyl acrylate, 2-hydroxypropyl acrylate, 3-hydroxypropyl acrylate and hydroxybutyl acrylate.

Typical commercial hydroxy functional monomers may contain up to 1% acrylic or methacrylic acid. During polymerization the acid can cause side reactions involving the silane monomers that broaden the molecular weight distribution of the acrylic polymer which will have harmful effects on solids content of paint, stability of paint and even cause gelation during copolymer preparation. Preferably the acid content of these hydroxy monomers should be limited to about 0.1%.

A silane-containing monomer useful in forming the acrylosilane polymer is an alkoxysilane having the following structural formula:

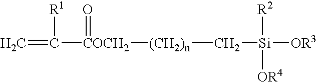

wherein R¹ is either H, CH₃, or CH₃CH₂; R² is either CH₃, CH₃CH₂, CH₃O, or CH₃CH₂O; R³ and R⁴ are CH₃ or CH₃CH₂; and n is 0 or a positive integer from 1 to 10.

Typical examples of such silanes are the acrylate alkoxy silanes, such as gamma-acryloxypropyltrimethoxy silane and the methacrylatoalkoxy silanes, such as gamma-methacryloxypropyltrimethoxy silane or gamma-trimethoxy silyl propyl methacrylate, and gamma-trimethoxy silyl propyl acrylate, and gamma-methacryloxypropyltris(2-methoxyethoxy) silane.

Other suitable alkoxysilane monomers have the following structural formula:

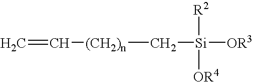

wherein R² is either CH₃, CH₃CH₂, CH₃O, or CH₃CH₂O; R³ and R⁴ are CH₃ or CH₃CH₂; and n is 0 or a positive integer from 1 to 10.

Examples of such alkoxysilanes are the vinylalkoxysilanes, such as vinyltrimethoxysilane, vinyltriethoxysilane and vinyltris(2-methoxyethoxy)silane. Other examples of such alkoxysilanes are the allylalkoxysilanes such as allyltrimethoxysilane and allyltriethoxysilane.

Additionally, further useful silane-containing monomers are acyloxysilanes, including acryloxysilane, methacryloxysilane and vinylacetoxysilanes, such as vinylmethyldiacetoxysilane, acryloxypropyltriacetoxysilane, and methacryloxypropyltriacetoxysilane. Mixtures of silane containing monomers are also suitable.

Silane functional macromonomers also can be used in forming the silane polymer. These macromonomers are the reaction product of a silane-containing compound, having a reactive group such as epoxide or isocyanate, with an ethylenically unsaturated non-silane-containing monomer having a reactive group, typically a hydroxyl or an epoxide group, that is co-reactive with the silane monomer. An example of a useful macromonomer is the reaction product of a hydroxy functional ethylenically unsaturated monomer such as a hydroxyalkyl acrylate or methacrylate having 1-8 carbon atoms in the alkyl group and an isocyanatoalkyl alkoxysilane such as isocyanatopropyltriethoxysilane.

Typical of such silane-functional macromonomers are those having the following structural formula:

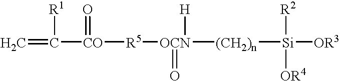

wherein R¹ is H or CH₃; R² is either CH₃, CH₃CH₂, CH₃O, or CH₃CH₂O; R³ and R⁴ are CH₃ or CH₃CH₂; R⁵ is an alkylene group having 1-8 carbon atoms; and n is an integer from 1 to 10.

In addition to the silane-forming polymer described heretofore, the reactive film-forming silane component can also be a monofunctional silane or silane-containing oligomer.

Consistent with the above mentioned components of the acrylosilane polymer, the following is an example of an acrylosilane polymer useful in the coating composition of this invention that contains the following constituents: 15-30% by weight styrene, 30-50% by weight isobutyl methacrylate, 15-30% by weight hydroxy ethyl methacrylate, and 15-30% by weight of methacryloxypropyl trimethoxy silane.

Typical polymerization catalysts used to form the acrylosilane polymer are azo type catalysts such as azo-bis-isobutyronitrile, peroxide catalysts such as t-butyl peracetate, di-t-butyl peroxide, t-butyl perbenzoate, and t-butyl peroctoate.

Typical solvents that can be used to polymerize the monomers and to form the coating composition are ketones such as methyl amyl ketone, isobutyl ketone, methyl ethyl ketone, aromatic hydrocarbons solvents such as toluene, xylene, “Solvesso” 100 aromatic solvent, ethers, esters, alcohols, acetates and mixtures of the above.

The composition of the present invention further includes a monomeric or polymeric alkylated melamine crosslinking agent that is partially or fully alkylated. The melamine crosslinking agent provides the benefit of lowering (VOC) volatile organic compound content at commercially acceptable application viscosities, while crosslinking during the bake to contribute to the integrity of the final film. One preferred melamine crosslinking agent is a methylated and butylated or isobutylated melamine formaldehyde resin that has a degree of polymerization of about 1-3. Generally, this melamine formaldehyde resin contains about 50% butylated groups or isobutylated groups and 50% methylated groups. Such crosslinking agents typically have a number average molecular weight of about 300-600 and a weight average molecular weight of about 500-1500. Examples of commercially available resins are “Cymel” 301, “Cymel” 303, “Cymel” 1168, “Cymel” 1161, “Cymel” 1158, “Resimine” 4514, “Resimine” 717, “Resimine” 747, “Resimine” 755, and “Resimine” 354, among many others. Preferably, the crosslinking agent is used in the amount of from about 10 to 45% by weight, and more preferably from about 15 to 35% by weight based on the weight of the binder composition.

The clearcoat composition of this invention contains about 0.5 to 5% by weight, based on the weight of the binder, of an aryl or alkyl acid phosphate curing agent. This curing agent may be either amine blocked or unblocked. This curing agent is employed to catalyze the crosslinking of the silane moieties of the acrylosilane polymer resulting in increased out of oven hardness.

In a preferred embodiment, phenyl acid phosphate is used in combination with an acrylosilane polymer to catalyze the crosslinking of silane moieties.

Preferably, the organic acid phosphate curing agent is used in the amount of from about 0.5 to from 0.5 to 5% by weight, and more preferably from 1 to 4% by weight, based on the weight of the binder of the composition. The level of phenyl acid phosphate catalyst may be varied to achieve the desired balance of properties at any given curing temperature.

The composition of the present invention may contain a high molecular weight dispersed polymer, used in the amount of about 0-30% by weight, based on the weight of the binder of the composition. A polymer dispersed in an organic (substantially non-aqueous) medium have been variously referred to, in the art, as a non-aqueous dispersion (NAD) polymer, a microgel, a non-aqueous latex, or a polymer colloid. See Poehlin et al., editor, SCIENCE AND TECHNOLOGY OF POLYMER COLLOIDS, Volume 1, pages 40-50 (1983); El-Asser, editor, FUTURE DIRECTIONS IN POLYMER COLLOIDS, pages 191-227 (1987); Barrett, DISPERSION POLYMERIZATION IN ORGANIC MEDIA (John Wiley 1975). See also U.S. Pat. Nos. 4,147,688; 4,180,489; 4,075,141; 4,415,681; 4,591,533; and 5,252,660 herein incorporated by reference. Microgel particles, necessarily cross-linked, have been used for years as impact modifiers for plastics, as rheology controllers for coatings, and in basecoats, to permit wet-on-wet application of paints.

Additionally, other film-forming and/or crosslinking solution polymers may be included in the present application. Examples include conventionally known acrylics, urethanes, carbamate functional polymers, polyesters, epoxides and mixtures thereof. One preferred optional film-forming polymer is a polyol, for example an acrylic polyol solution polymer of polymerized monomers. Such monomers may include any of the aforementioned alkyl acrylates and/or methacrylates. The polyol polymer preferably has a hydroxyl number of about 50-200 and a weight average molecular weight of about 1,000-200,000 and preferably about 1,000-30,000. To improve the weatherability of the clear coat, ultraviolet light stabilizers or a combination of ultraviolet light stabilizers can be added to the clear coat composition in the amount of 0.5 to 7% by weight, based on the weight of the binder. Such stabilizers include ultraviolet light absorbers, screeners, quenchers, and hindered amine light stabilizers. Also, an antioxidant can be added, in the amount 0.1-5% by weight, based on the weight of the binder.

Typical ultraviolet light stabilizers that are useful include benzophenones, triazoles, triazines, benzoates, hindered amines and mixtures thereof. Specific examples of ultraviolet stabilizers are disclosed in U.S. Pat. No. 4,591,533, the entire disclosure of which is incorporated herein by reference. For good durability, a blend of “Tinuvin” 1130, “Tinuvin” 384 and “Tinuvin” 123 (hindered amine light Stablizer), all commercially available from Ciba-Geigy, is preferred.

The clear coating composition may also include other conventional formulation additives such as flow control agents, for example, such as “Resiflow” S (polybutylacrylate), “BYK” 320 and 325 (high molecular weight polyacrylates); and rheology control agents, such as fumed silica.

Conventional solvents and diluents described above are used to disperse an/or dilute the above mentioned polymers of the clear coating composition. Typical solvents and diluents include toluene, xylene, butyl acetate, acetone, methyl isobutyl ketone, methyl ethyl ketone, methanol, isopropanol, butanol, hexane, acetone, ethylene glycol, monoethyl ether, VM and P naphtha, mineral spirits, heptane and other aliphatic, cycloaliphatic aromatic hydrocarbons, esters, ethers and ketones and the like.

Typical basecoats used in combination with the clear coating composition, comprise as the film forming binder a polyurethane, an acrylourethane, a silane resin, an acrylic resin and a crosslinking agent such as a polyisocyanate or an alkylated melamine resin. The basecoat can be waterborne or solvent based solution or dispersion. The basecoat contains pigments such as are conventionally used including metallic flake pigments such as aluminum flake and mica flake pigments.

Both the basecoat and the clear coat are applied by conventional techniques such as spraying, electrostatic spraying, dipping, brushing, and flow coating.

The following examples illustrate the invention. All parts and percentages are on a weight basis unless otherwise indicated. Molecular weights are determine by GPC (Gel Permeation Chromatography) using polymethyl methacrylate as the standard.

Test Methods

The gloss of the coating composition was determined under ASTM D-523-67 Test by measuring the reflectance at 20° angle of reflection through the glossmeter Tri-Gloss Model supplied by Byk-Gardner. The scale runs from 1-100 with 100 representing the highest gloss.

The Tukon Hardness of the cured coating was measured under ASTM Method is E384 by using. Wilson Tukon Tester supplied by Instron Corporation of Canton, Mass.

The Wet Mar Resistance of the coating was measured by marring the coating with a felt pad soaked in a 3% slurry of aluminum oxide in water. The marring was accomplished using a Daiei® Rub Tester. The test used 10 cycles with a weight of 500 grams. The rating, as measured by image analysis, is the percent of the surface that remained unmarred. A reading of 60 and above was considered acceptable.

The Dry Mar Resistance of the coating was measured by marring the coating with a felt pad coated with Bon Ami® cleanser. The marring was accomplished using a Daiei® Rub Tester. The test used 15 cycles with a weight of 700 grams. The rating, as measured by image analysis, is the percent of the surface that remained unmarred. A reading of 80 and above was considered acceptable.

Field Environmental Etch Resistance was measured by exposing coated test panels at a test facility in Jacksonville, Fla. for 14 weeks during the summer. Comparisons were made to standard melamine coated panels. A visual scale of 1 to 12 was used to determine etch resistance, with 12 being worst (melamine coatings are typically rated at 10 to 12) and 1 being the best.

### EXAMPLES

The following polymers and resins were prepared and used in clearcoat examples I through IV.

Acrylosilane Copolymer A

The following constituents were charged into a mixing vessel equipped with a stirrer:

PARTS BY WEIGHT

| | |
|---|---|
| Styrene monomer (S) | 25.0 |
| Isobutyl methacrylate monomer (IBMA) | 23.0 |
| n-Butyl Acrylate monomer (nBA) | 2.0 |
| Hydroxy propyl acrylate monomer (HPA) | 20.0 |
| Gamma-methacryloxypropyl trimethoxy | 30.0 |
| silane monomer (TPM) | |
| 2,2′-azobis (2-methyl butyronitrile) | 8.0 |
| Total | 108.0 |

The above constituents were mixed and charged into the vessel containing 44 parts of a 2/1 Aromatic 100/n-butanol solvent mixture held at 123 degree C. with constant mixing over a 4 hour period. The resulting polymer solution had a polymer solids content of about 70.1% and the polymer had a composition of S/IBMA/nBAIHPA/TPM of 25/23/2/20/30 and a Gardner Holdt viscosity of V and a weight average molecular weight of about 7,000.

Acrylosilane Copolymer B

The following constituents were charged into a mixing vessel equipped with a stirrer:

PARTS BY WEIGHT

| | |
|---|---|
| Styrene monomer (S) | 25.0 |
| Isobutyl methacrylate monomer (IBMA) | 25.0 |
| n-Butyl acrylate monomer (nBA) | 5.0 |
| Hydroxy propyl acrylate monomer (HPA) | 15.0 |
| Gamma-methacryloxypropyl trimethoxy | 30.0 |
| silane monomer (TPM) | |
| 2,2′-azobis (2-methyl butyronitrile) | 8.0 |
| Total | 108.0 |

The above constituents were mixed and charged into the vessel containing 44 parts of a 2/1 Aromatic 100/n-butanol solvent mixture held at 128 degree C. with constant mixing over a 4 hour period. The resulting polymer solution had a polymer solids content of about 70.1% and the polymer had a composition of S/IBMA/nBA/HPA/TPM of 25/25/5/15/30 and a Gardner Holdt viscosity of V and a weight average molecular weight of about 7,000.

Acrylic Non-Aqueous Dispersion (NAD) Resin

An acrylic NAD resin was prepared by charging the following constituents into a reaction vessel equipped as above containing 56.7 parts of a stabilizer resin solution and polymerizing the constituents: 15 parts styrene monomer (S), 36.5 parts, methyl methacrylate monomer (MMA), 18 parts, methyl acrylate (MA), 25 parts, 2-hydroxyethyl acrylate monomer (HEA), 1.5 parts glycidyl methacrylate monomer (GMA), 4.0 parts methacrylic acid (MAA), 2 parts t-butyl peroctoate.

The stabilizer resin solution has a solids content of about 64% in a solvent blend of 85% xylene and 15% butanol and the resin is of styrene, butyl methacrylate, butyl acrylate, 2-hydroxyethyl acrylate, methacrylic acid and glycidyl methacrylate in a weight ratio of 14.7/27.5143.9/9.8/2.3/1.7. The dispersing liquid for the non-aqueous dispersion is 5% isopropanol, 29% heptane, 54% VMP Naphtha, and 12% n-butanol and the dispersion has a 65% solids content and the dispersed polymer particles have a particle size of about 200-300 nanometers.

Non-Aqueous Dispersed (NAD) Microgel Resin

A NAD microgel resin was prepared by initially charging the following constituents into a reaction vessel equipped as above: 1.4 parts 2,2′-azobis (2-methyl butyronitrile), 4.7 parts Super Stablizer HCM—8788 from PPG Industries, 15.0 parts methyl methacrylate, 97.5 parts mineral spirits, and 73.5 parts heptane. Added to the above precharged mixture at reflux temperature, over 180 minutes, is the following premixture: 179 parts methyl methacrylate, 2.8 parts glycidyl methacrylate, 2.8 parts methacrylic acid, 58.5 parts Super Stablizer HCM—8788, 1.1 parts N,N-dimethylethanolamine, 75.5 parts styrene, 23.5 parts hydroxy ethyl acrylate, 32.5 parts mineral spirits, and 199 parts heptane. A premixture of 2 parts 2,2′-azobis (2-methyl butyronitrile), 13 parts toluene, and 30.5 parts mineral spirits is then added to the above at reflux, over a 180 minutes, and then the solution is held at reflux for 120 minutes. 250 parts of solvent are then stripped off. Lastly, 246 parts of Resimine 755 melamine-formaldehyde resin, from Solutia, Inc., is added to the above solution.

Clearcoat Compositions Used with Solventborne Basecoats

Examples I & II illustrate clearcoat compositions according to the present invention, which are applied over solventborne basecoats. The following ingredients were added with mixing under a dry nitrogen blanket:

| | Example I | Example II |
|---|---|---|
| NAD Microgel Resin | 4.50 | 4.50 |
| n-Butyl Alcohol | 7.00 | 7.00 |
| “Cymel” 1168 | 1.64 | 1.64 |
| Melamine Resin¹ | | |
| “Cymel” 1161 | 9.61 | 9.61 |
| Melamine Resin¹ | | |
| Fumed Silica Pigment | 3.33 | 3.33 |
| Dispersion UV | | |
| Absorber/Hindered Amine | | |
| Light Stabilizer | 7.08 | 7.08 |
| Solution (5.5% xylene, | | |
| 69.5% “Solvesso” 100 | | |
| aromatic solvent, 8.5% | | |
| “Tinuvin” 123², 13.7% | | |
| “Tinuvin” 928², 2.8% | | |
| “Tinuvin” 900²) | | |
| “Disparlon” LC-955 | 0.60 | 0.60 |
| Surfactant (product of | | |
| King Industries) | | |
| Dodecylbenzene | 1.61 | 0.89 |
| Sulfonic Acid Solution | | |
| (48% DDBSA, 37.2% | | |
| n-butanol, 14.7% DIIOPA) | | |
| Phenyl Acid Phosphate Solution | — | 2.67 |
| (44.8% Phenyl acid | | |
| phosphate, 27.8% | | |
| Diisopropanol amine, | | |
| 27.4% n-Butanol) | | |
| Acrylic NAD Resin | 18.30 | 20.00 |
| Trimethyl ortho-Formate | 1.50 | 1.50 |
| Acrylosilane Copolymer A | 42.00 | 40.50 |

¹Alkylated melamine formaldehyde resin, a product of Cytec, Inc
²Product of CibaGeigy, Inc.

The above clear coating compositions were adjusted to a spray viscosity of 38 sec. #4 Ford Cup with ethoxy 3-ethyl propionate solvent. The clear coating compositions were spray applied to phosphated steel panels primed with an electrocoated primer and black solventborne basecoats. The clear coats were spray-coated over the basecoated panels to provide a cured film thickness of 50.8 microns (2.0 mils), and then cured by baking for 30 minutes at 140 degree C. The resulting basecoat/clearcoat coatings exhibited the following properties when subjected to the testing described above.

| | Example I | Example II |
|---|---|---|
| Out of Oven Tukon Hardness | 12.1 | 15.1 |
| Mar Resistance | | |
| Initial 20° Gloss | 82 | 90 |
| Dry Mar % Retention | 90 | 93% |
| Wet Mar % Retention | 88% | 92% |

Clearcoat Compositions Used with Waterborne Basecoats

Examples III & IV illustrate clearcoat compositions according to the present invention, which are applied over waterborne basecoats, and cured at a lower temperature than Examples I & II. The following ingredients were added with mixing under a dry nitrogen blanket:

| | Example III | Example IV |
|---|---|---|
| “Cymel” 1168 | 8.46 | 8.46 |
| Melamine Resin¹ | | |
| “Resimine” 717 | 3.36 | 3.36 |
| Melamine Resin³ | | |
| Fumed Silica Pigment | 6.21 | 6.21 |
| Dispersion UV | | |
| Absorber/Hindered Amine | | |
| Light Stabilizer | 7.58 | 7.58 |
| Solution (5.5% xylene, | | |
| 69.5% “Solvesso” | | |
| 100 aromatic solvent, | | |
| 8.5% “Tinuvin” 123², | | |
| 13.7% “Tinuvin” 928², | | |
| 2.8% “Tinuvin” 900²) | | |
| Dodecylbenzene | 3.20 | |
| Sulfonic Acid Solution | | |
| (48% DDBSA, 37.2% | | |
| n-butanol, 14.7% DIIOPA) | | |
| n-Butanol | 5.40 | 5.40 |
| “Disparlon” | 0.28 | 0.28 |
| LC-955 Surfactant | | |
| (product of King | | |
| Industries) | | |
| 10% DC-57 Surfactant | 0.06 | 0.06 |
| in Xylene (product of | | |
| Dow Corning) | | |
| Phenyl Acid Phosphate Solution | | 3.20 |
| (44.8% Phenyl acid | | |
| phosphate, 27.8% | | |
| Diisopropanol amine, | | |
| 27.4% n-Butanol) | | |
| Acrylic NAD Resin | 21.49 | 21.49 |
| “Solvesso” | 0.79 | 0.79 |
| 100 Aromatic solvent | | |
| Methyl Alcohol | 1.00 | 1.00 |
| Trimethyl ortho-Formate | 1.82 | 1.82 |
| Acrylosilane Copolymer B | 42.16 | 40.16 |

¹Alkylated melamine formaldehyde resin, a product of Cytec, Inc
²Product of CibaGeigy, Inc.
³Alkylated melamine formaldehyde resin, a product of Solutia, Corp.

The above clear coating compositions were adjusted to a spray viscosity of 38 sec. #4 Ford Cup with ethoxy 3-ethyl propionate solvent. The clear coating compositions were spray applied to phosphated steel panels primed with an electrocoated primer and black waterborne basecoats. The clear coats were spray-coated over the basecoated panels to provide a cured film thickness of 2.0 mils, and then cured by baking for 30 minutes at 90 degree C. The resulting basecoat/clearcoat coatings exhibited the following properties when subjected to Tukon Hardness testing, as described above.

| | Example III | Example IV |
|---|---|---|
| Out of Oven | 3.4 | 10.0 |
| Tukon Hardness | | |
| Field Environmental | 6.4 | 4.2 |
| Etch Resistance | | |

Various modifications, alterations, additions, or substitutions of the components of the composition and process of this invention will be apparent to those skilled in the art without departing from the scope and spirit of this invention and it should be understood that this invention is not unduly limited to the illustrative embodiments set forth herein.

What is claimed is:

1. A coating composition comprising 40 to 70% by weight of film forming binder and 30 to 60% by weight of a volatile liquid carrier for the binder, wherein the binder comprises:
a. from about 25 to 98.5% by weight of an acrylosilane polymer containing about 30 to 95% by weight based, based on the weight of the acrylosilane polymer, of polymerized monomers of styrene, alkyl (meth)acrylates having 1-12 carbon atoms in the alkyl group and hydroxy alkyl (meth)acrylates having 1-4 carbon atoms in the alkyl group and any mixtures thereof and 5 to 70% by weight, based on the weight of the polymer, of polymerized ethylenically unsaturated monomers containing reactive silane groups and the polymer has a weight average molecular weight of about 1,000-30,000;
b. from about 0.5 to 5% by weight, based on the weight of the binder, of a curing agent, employed to catalyze the crosslinking of the silane moieties in said acrylosilane polymer, said curing agent is an aryl or alkyl acid phosphate, either amine blocked or unblocked;
c. from about 1 to 40% by weight, based upon the weight of the binder, of an alkylated melamine crosslinking agent; and
d. from about 0 to 30% by weight, based upon the weight of the binder, of non-aqueous dispersed polymer, urethane polymer, polyester resin, acrylic polyol resin, and any mixture thereof.

2. The coating composition of claim 1 in which the mono ethylenically unsaturated silane monomer has the following structural formula: 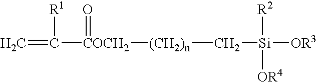
wherein R¹ is either H, CH₃, or CH₃CH₂; R² is either CH₃, CH₃CH₂, CH₃O, or CH₃CH₂O; R³ and R⁴ are CH₃ or CH₃CH₂; and n is 0 or a positive integer from 1 to 10.

3. The coating composition of claim 1 in which said mono ethylenically unsaturated silane monomer has the following structural formula: 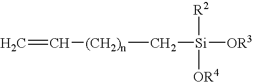
wherein R² is either CH₃, CH₃CH₂, CH₃O, or CH₃CH₂O; R³ and R⁴ are CH₃ or CH₃CH₂; and n is 0 or a positive integer from 1 to 10.

4. The coating composition of claim 1 in which said acrylosilane curing agent is phenyl acid phosphate or its salt.

5. The coating composition of claim 2 in which the acrylosilane polymer consists essentially of 35 to 80% by weight, based on the weight of the acrylosilane polymer, of polymerized monomers selected from the group consisting of alkyl acrylates, alkyl methacrylates each having 1-8 carbon atoms in the alkyl group and styrene, 10 to 25% by weight, based on the weight of the acrylosilane polymer of polymerized monomers selected from the group consisting of hydroxyalkyl methacrylates and hydroxyalkyl acrylates each having 1-4 carbon atoms in the alkyl groups and 10 to 40% by weight, of the mono ethylenically unsaturated silane monomer.

6. The coating composition of claim 2 in which said acrylosilane curing agent is phenyl acid phosphate or its salt.

7. The coating composition of claim 2 which contains about 0.5 to 5% by weight, based on the weight of the binder, of ultraviolet light absorbers.

8. The coating composition of claim 2 which contains about 0.1 to 2% by weight, based on the weight of the binder, of hindered amine light stabilizers.

9. The coating composition of claim 3 in which the acrylosilane polymer consists essentially of 35 to 80% by weight, based on the weight of the acrylosilane polymer, of polymerized monomers selected from the group consisting of alkyl acrylates, alkyl methacrylates each having 1-8 carbon atoms in the alkyl group and styrene, 10 to 25% by weight, based on the weight of the acrylosilane polymer of polymerized monomers selected from the group consisting of hydroxyalkyl methacrylates and hydroxyalkyl acrylates each having 1-4 carbon atoms in the alkyl groups and 10 to 40% by weight, of the mono ethylenically unsaturated silane monomer.

10. The coating composition of claim 3 in which said acrylosilane curing agent is phenyl acid phosphate or its salt.

11. The coating composition of claim 3 which contains about 0.5 to 5% by weight, based on the weight of the binder, of ultraviolet light absorbers.

12. The coating composition of claim 3 which contains about 0.1 to 2% by weight, based on the weight of the binder, of hindered amine light stabilizers.

13. A process for applying the coating composition of claim 1 to a substrate and subsequently drying and curing such coating on such substrate.

14. A substrate coated with a dried cured layer of the coating composition of claim 1.
